(19) United States
(12) Patent Application Publication
(10) Pub. No.: US 2021/0304206 A1
(43) Pub. Date: Sep. 30, 2021

(54) System and Method for Processing a Transaction Based on a Recovery Scoring Model

(71) Applicant: Visa International Service Association, San Francisco, CA (US)

(72) Inventors: Gurpreet Juneja, Thornton, CO (US); Shane Malloy, Castle Rock, CO (US); Richard S. Fisher, JR., Monument, CO (US)

(21) Appl. No.: 17/215,008

(22) Filed: Mar. 29, 2021

Related U.S. Application Data
(60) Provisional application No. 63/000,647, filed on Mar. 27, 2020.

(51) Int. Cl. G06Q 20/40; G06N 20/00; G06Q 20/20

(52) U.S. Cl. CPC G06Q 20/4016; G06Q 20/206; G06N 20/00

(57) ABSTRACT

A method, system, and computer program product is provided for processing a transaction based on a recovery scoring model. The method includes receiving a transaction request for a payment, the transaction request including transaction data including a payment amount; generating a fraud risk score based on the transaction data and merchant data associated with the merchant; generating a recovery score based on the transaction data and merchant data associated with the merchant, the recovery score representing a likelihood that an issuer system associated with the account of the user will be able to recover at least a portion of the payment amount if the payment transaction is reversed; determining at least one authorization action for processing the transaction request based on the recovery score and the fraud risk score; and processing the transaction request based on the at least one authorization action.

### CROSS REFERENCE TO RELATED APPLICATION

This application claims the benefit of U.S. Provisional Application No. 63/000,647, filed on Mar. 27, 2020, the entire content of which is hereby incorporated by reference.

### BACKGROUND

### 1. Field

This disclosure relates generally to a transaction scoring model and, in non-limiting embodiments, systems, methods, and computer program products for processing a transaction based on a recovery scoring model.

### 2. Technical Considerations

Fraudulent transactions cost transaction service providers a significant amount of time, money, and resources. In order to avoid costs of fraudulent transactions, it is possible to determine how likely a transaction is to be fraudulent. Transactions that have a high likelihood of being fraudulent can be denied. However, not all fraudulent transactions are equal. It may be easier to recover funds from some fraudulent transactions than other fraudulent transactions. However, currently, the likelihood of recovering funds is not determined at the time of transactions thereby requiring significant resources to be expended in attempting to recover for such transactions. The ability to determine the likelihood of recovering funds in the event that a transaction is fraudulent would allow transaction service providers to authorize more transactions when there is a high likelihood of recovering funds.

### SUMMARY

According to non-limiting embodiments or aspects, provided is a computer-implemented method, comprising: receiving, with at least one processor, a transaction request for a payment transaction to be made from an account of a user to a merchant, the transaction request comprising transaction data including a payment amount; generating, with at least one processor, a fraud risk score based on the transaction data and merchant data associated with the merchant, the fraud risk score representing a likelihood that the transaction is fraudulent; generating, with at least one processor, a recovery score based on the transaction data and merchant data associated with the merchant, the recovery score representing a likelihood that an issuer system associated with the account of the user will be able to recover at least a portion of the payment amount if the payment transaction is reversed; determining, with at least one processor, at least one authorization action for processing the transaction request based on the recovery score and the fraud risk score; and processing, with at least one processor, the transaction request based on the at least one authorization action.

In non-limiting embodiments or aspects, processing the transaction request may occur at a point of sale. The at least one authorization action may be determined based on the recovery score in response to determining that the fraud risk score is above a threshold value. The recovery score may be generated based on at least one machine learning model.

In non-limiting embodiments or aspects, the at least one authorization action may comprise approving the transaction and sending an alert, and determining the at least one authorization action may comprise determining the fraud risk is below a threshold value and the recovery score is above a threshold value. The at least one authorization action may comprise approving the transaction and sending an alert, and determining the at least one authorization action may comprise determining the fraud risk is above a threshold value and the recovery score is below a threshold value. The at least one authorization action may comprise approving the transaction, and determining the at least one authorization action may comprise determining the fraud risk is below a threshold value and the recovery score is below a threshold value. The at least one authorization action may comprise declining the transaction, and determining the at least one authorization action may comprise determining the fraud risk is above a threshold value and the recovery score is above a threshold value.

According to non-limiting embodiments or aspects, provided is a system for processing a transaction, the system comprising at least one server computer including at least one processor, the at least one server computer programed and/or configured to: receive a transaction request for a payment transaction to be made from an account of a user to a merchant, the transaction request comprising transaction data including a payment amount; generate a fraud risk score based on the transaction data and merchant data associated with the merchant, the fraud risk score representing a likelihood that the transaction is fraudulent; generate a recovery score based on the transaction data and merchant data associated with the merchant, the recovery score representing a likelihood that an issuer system associated with the account of the user will be able to recover at least a portion of the payment amount if the payment transaction is reversed; determine at least one authorization action for processing the transaction request based on the recovery score and the fraud risk score; and process the transaction request based on the at least one authorization action.

In non-limiting embodiments or aspects, the at least one server computer may be programed and/or configured to, process the transaction request at a point of sale. The at least one server computer may be programed and/or configured to, when determining the at least one authorization action, base the determination of the at least one authorization action on the recovery score in response to determining that the fraud risk is above a threshold value. The at least one server computer may be programed and/or configured to, generate the recovery score based on at least one machine learning model.

In non-limiting embodiments or aspects, the at least one server computer may be programed and/or configured to, when determining the at least one authorization action, determine the fraud risk is below a threshold value and the recovery score is above a threshold value, and when processing the transaction request based on the at least one authorization action, approve the transaction and send an alert. The at least one server computer may be programed and/or configured to, when determining the at least one authorization action, determine the fraud risk is above a threshold value and the recovery score is below a threshold value, and when processing the transaction request based on the at least one authorization action, approve the transaction and send an alert. The at least one server computer may be programed and/or configured to, when determining the at least one authorization action, determine the fraud risk is below a threshold value and the recovery score is below a threshold value, and when processing the transaction request based on the at least one authorization action, approve the transaction. The at least one server computer may be programed and/or configured to, when determining the at least one authorization action, determine the fraud risk is above a threshold value and the recovery score is above a threshold value, and when processing the transaction request based on the at least one authorization action, decline the transaction.

According to non-limiting embodiments or aspects, provided is a computer program product for processing a transaction, comprising at least one non-transitory computer-readable medium including program instructions that, when executed by at least one processor, cause the at least one processor to: receive a transaction request for a payment transaction to be made from an account of a user to a merchant, the transaction request comprising transaction data including a payment amount; generate a fraud risk score based on the transaction data and merchant data associated with the merchant, the fraud risk score representing a likelihood that the transaction is fraudulent; generate a recovery score based on the transaction data and merchant data associated with the merchant, the recovery score representing a likelihood that an issuer system associated with the account of the user will be able to recover at least a portion of the payment amount if the payment transaction is reversed; determine at least one authorization action for processing the transaction request based on the recovery score and the fraud risk score; and process the transaction request based on the at least one authorization action.

In non-limiting embodiments or aspects, the one or more instructions may further cause the at least one processor to process the transaction request at a point of sale. The one or more instructions may further cause the at least one processor to, when determining the at least one authorization action, determine the fraud risk is below a threshold value and the recovery score is below a threshold value, and when processing the transaction request based on the at least one authorization action, approve the transaction. The one or more instructions may further cause the at least one processor to, when determining the at least one authorization action, determine the fraud risk is above a threshold value and the recovery score is above a threshold value, and when processing the transaction request based on the at least one authorization action, decline the transaction.

Other non-limiting embodiments or aspects will be set forth in the following numbered clauses:

Clause 1: A computer-implemented method, comprising: receiving, with at least one processor, a transaction request for a payment transaction to be made from an account of a user to a merchant, the transaction request comprising transaction data including a payment amount; generating, with at least one processor, a fraud risk score based on the transaction data and merchant data associated with the merchant, the fraud risk score representing a likelihood that the transaction is fraudulent; generating, with at least one processor, a recovery score based on the transaction data and merchant data associated with the merchant, the recovery score representing a likelihood that an issuer system associated with the account of the user will be able to recover at least a portion of the payment amount if the payment transaction is reversed; determining, with at least one processor, at least one authorization action for processing the transaction request based on the recovery score and the fraud risk score; and processing, with at least one processor, the transaction request based on the at least one authorization action.

Clause 2: The computer-implemented method of clause 1, wherein processing the transaction request occurs at a point of sale.

Clause 3: The computer-implemented method of clause 1 or 2, wherein the at least one authorization action is determined based on the recovery score in response to determining that the fraud risk is above a threshold value.

Clause 4: The computer-implemented method of any of clauses 1-3, wherein the recovery score is generated based on at least one machine learning model.

Clause 5: The computer-implemented method of any of clauses 1-4, wherein the at least one authorization action comprises approving the transaction and sending an alert, and wherein determining the at least one authorization action comprises determining the fraud risk is below a threshold value and the recovery score is above a threshold value.

Clause 6: The computer-implemented method of any of clauses 1-5, wherein the at least one authorization action comprises approving the transaction and sending an alert, and wherein determining the at least one authorization action comprises determining the fraud risk is above a threshold value and the recovery score is below a threshold value.

Clause 7: The computer-implemented method of any of clauses 1-6, wherein the at least one authorization action comprises approving the transaction, and wherein determining the at least one authorization action comprises determining the fraud risk is below a threshold value and the recovery score is below a threshold value.

Clause 8: The computer-implemented method of any of clauses 1-7, wherein the at least one authorization action comprises declining the transaction, and wherein determining the at least one authorization action comprises determining the fraud risk is above a threshold value and the recovery score is above a threshold value.

Clause 9: A system for processing a transaction, the system comprising at least one server computer including at least one processor, the at least one server computer programed and/or configured to: receive a transaction request for a payment transaction to be made from an account of a user to a merchant, the transaction request comprising transaction data including a payment amount; generate a fraud risk score based on the transaction data and merchant data associated with the merchant, the fraud risk score representing a likelihood that the transaction is fraudulent; generate a recovery score based on the transaction data and merchant data associated with the merchant, the recovery score representing a likelihood that an issuer system associated with the account of the user will be able to recover at least a portion of the payment amount if the payment transaction is reversed; determine at least one authorization action for processing the transaction request based on the recovery score and the fraud risk score; and process the transaction request based on the at least one authorization action.

Clause 10: The system of clause 9, wherein the at least one server computer is programed and/or configured to, process the transaction request at a point of sale.

Clause 11: The system of clause 9 or 10, wherein the at least one server computer is programed and/or configured to, when determining the at least one authorization action, base the determination of the at least one authorization action on the recovery score in response to determining that the fraud risk is above a threshold value.

Clause 12: The system of any of clauses 9-11, wherein the at least one server computer is programed and/or configured to, generate the recovery score based on at least one machine learning model.

Clause 13: The system of any of clauses 9-12, wherein the at least one server computer is programed and/or configured to, when determining the at least one authorization action, determine the fraud risk is below a threshold value and the recovery score is above a threshold value, and when processing the transaction request based on the at least one authorization action, approve the transaction and send an alert.

Clause 14: The system of any of clauses 9-13, wherein the at least one server computer is programed and/or configured to, when determining the at least one authorization action, determine the fraud risk is above a threshold value and the recovery score is below a threshold value, and when processing the transaction request based on the at least one authorization action, approve the transaction and send an alert.

Clause 15: The system of any of clauses 9-14, wherein the at least one server computer is programed and/or configured to, when determining the at least one authorization action, determine the fraud risk is below a threshold value and the recovery score is below a threshold value, and when processing the transaction request based on the at least one authorization action, approve the transaction.

Clause 16: The system of any of clauses 9-15, wherein the at least one server computer is programed and/or configured to, when determining the at least one authorization action, determine the fraud risk is above a threshold value and the recovery score is above a threshold value, and when processing the transaction request based on the at least one authorization action, decline the transaction.

Clause 17: A computer program product for processing a transaction, comprising at least one non-transitory computer-readable medium including program instructions that, when executed by at least one processor, cause the at least one processor to: receive a transaction request for a payment transaction to be made from an account of a user to a merchant, the transaction request comprising transaction data including a payment amount; generate a fraud risk score based on the transaction data and merchant data associated with the merchant, the fraud risk score representing a likelihood that the transaction is fraudulent; generate a recovery score based on the transaction data and merchant data associated with the merchant, the recovery score representing a likelihood that an issuer system associated with the account of the user will be able to recover at least a portion of the payment amount if the payment transaction is reversed; determine at least one authorization action for processing the transaction request based on the recovery score and the fraud risk score; and process the transaction request based on the at least one authorization action.

Clause 18: The computer program product of clause 17, wherein the one or more instructions further cause the at least one processor to, process the transaction request at a point of sale.

Clause 19: The computer program product of clause 17 or 18, wherein the one or more instructions further cause the at least one processor to, when determining the at least one authorization action, determine the fraud risk is below a threshold value and the recovery score is below a threshold value, and when processing the transaction request based on the at least one authorization action, approve the transaction.

Clause 20: The computer program product of any of clauses 17-19, wherein the one or more instructions further cause the at least one processor to, when determining the at least one authorization action, determine the fraud risk is above a threshold value and the recovery score is above a threshold value, and when processing the transaction request based on the at least one authorization action, decline the transaction.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying figures, in which:

FIG. 1 is a schematic diagram of a system for processing a transaction based on a recovery scoring model according to a non-limiting embodiment;

FIG. 2 is another schematic diagram of a system for processing a transaction based on a recovery scoring model according to a non-limiting embodiment;

FIG. 3 is a flow diagram for a method for processing a transaction based on a recovery scoring model according to a non-limiting embodiment;

FIG. 4 is a diagram of recovery score determinations according to non-limiting embodiments; and

FIG. 5 illustrates example components of a device used in connection with non-limiting embodiments.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “graphical user interface” (GUI) refers to a generated display, such as one or more displays with which a user may interact, either directly or indirectly (e.g., through a keyboard, mouse, touchscreen, etc.).

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computing devices operated by or on behalf of an issuer institution, such as a server computer executing one or more software applications. For example, an issuer system may include one or more authorization servers for authorizing a transaction.

Non-limiting embodiments provide for a system for processing a transaction, such as a transaction between a consumer and a merchant for goods and/or services, based on a recovery scoring model. Non-limiting embodiments improve upon existing transaction processing systems by leveraging the determination of two separate scores, a fraud risk score and a recovery risk score, to determine an authorization action for a requested transaction. Through the use of separate scores, authorization decisions can be made dynamically and in a manner that reduces fraudulent transactions and, as a result, results in expending fewer computing resources for processing chargebacks, reversals, disputes, and/or the like. Non-limiting embodiments also permit for the automation of risk determinations and for improvement of the recovery scoring model over time through training. By leveraging the recovery score with the fraud risk score, transactions that would have been denied based solely on the fraud risk score can be approved with decreased risk of losing funds in the event that the transaction is fraudulent. Increased authorizations of transactions with high likelihood of recovery will increase the total number of transactions that are authorized, resulting in a better consumer experience. Leveraging the recovery score will also result in a higher rate of recovery.

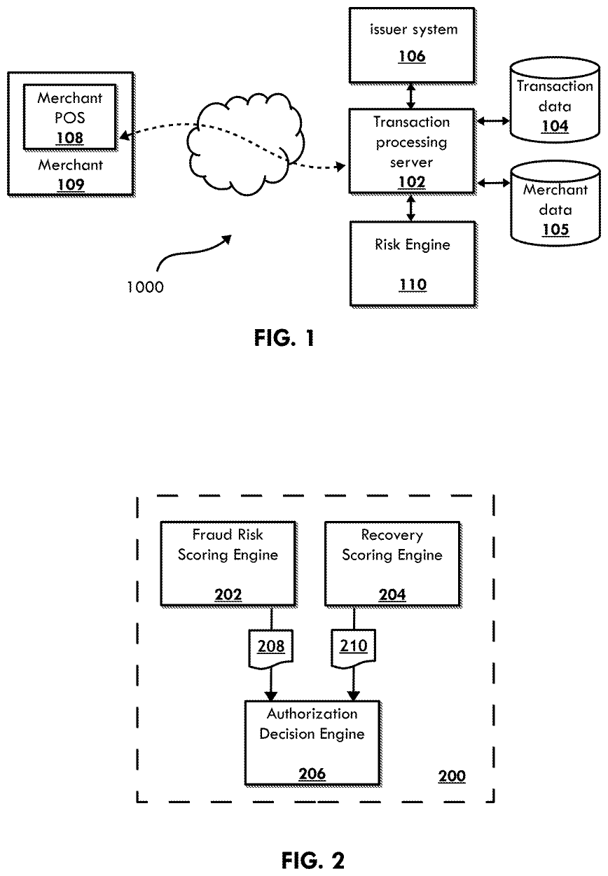

Referring to FIG. 1, shown is a system 1000 for processing a transaction based on a recovery scoring model according to a non-limiting embodiment. As shown, a transaction processing system 102 is in communication with a merchant system 109 and, in particular, a merchant POS system 108 that is part of the merchant system 109. The transaction processing system 102 may communicate with the merchant system 108 via a payment gateway (not shown in FIG. 1), an acquirer system (not shown in FIG. 1), directly via one or more APIs, and/or in any other manner. In some non-limiting embodiments, the merchant system 109 is operated by a brick-and-mortar retailer having a POS system 108 for in-person transactions. In some non-limiting embodiments, the merchant system 109 may be one or more server computers configured to request transactions initiated by consumers through one or more web pages, applications, and/or the like.

With continued reference to FIG. 1, the transaction processing system 102 may be in communication with one or more data storage devices including a transaction database 104 and a merchant database 105. It will be appreciated that various data structures and arrangements may be used to store and maintain transaction data and merchant data in one or more data storage devices. The merchant database 105 may include merchant data relating to a merchant, such as one or more merchant identifiers, merchant category codes (MCCs), transaction histories, fraud histories, dispute histories, recovery histories and outcomes, account information, merchant participation in fraud deflection services (e.g., Verifi™, Visa Resolve Online, Ethoca™), and/or the like. The transaction database 104 may include transaction data relating to one or more previous transactions processed by the transaction processing system including, for example, one or more merchant identifiers, account identifiers for consumers, transaction values, transaction dates/times, and/or the like.

Still referring to FIG. 1, the transaction processing system 102 is in communication with one or more issuer systems 106 that correspond to consumer accounts. The transaction processing system 102 may, for example, obtain authorization from the issuer system 106 prior to processing a transaction for a consumer based on the consumer's account identifier if the issuer system 106 manages and corresponds to that account.

With continued reference to FIG. 1, the transaction processing system 102 is also in communication with a risk engine 110, which may include hardware and/or software configured to generate one or more risk scores. The risk engine 110 may be part of the transaction processing system 102, may be a separate system local to the transaction processing system 102, may be a separate system remote from the transaction processing system 102, or may be part of any other system in a payment processing network such as, for example, an issuer system 106. The risk engine 110 receives a request for a risk determination from the transaction processing system 102 along with merchant data from the merchant database 105 and transaction data from the transaction database 104. Based on the inputted data, the risk engine 110 outputs an authorization action relating to the transaction. In some non-limiting embodiments, the risk engine 110 may be in direct communication with the transaction database 104, merchant database 105, and/or one or more other databases for retrieving merchant data and/or transaction data.

Referring now to FIG. 2, a risk engine 200 is shown according to a non-limiting embodiment. The risk engine 200 includes a fraud risk scoring engine 202, a recovery scoring engine 204, and an authorization decision engine 206. Each of the fraud risk scoring engine 202, recovery scoring engine 204, and authorization decision engine 206 may include hardware and/or software. Although the engines 202, 204, 206 are shown as being separate in FIG. 2, it will be appreciated that the engines 202, 204, 206 may be part of the same software application or different software applications and may be local or remote to each other.

Still referring to FIG. 2, the fraud risk scoring engine 202 is configured to generate a fraud risk score 208 for a transaction that represents a likelihood that the requested transaction is fraudulent. For example, the fraud risk scoring engine 202 may process transaction parameters from the requested transaction (e.g., merchant identifier, account identifier, MCC, transaction value/amount, date, time, POS entry mode, terminal entry capability, service code, electronic commerce indicator, country code for a merchant, postal code, card acceptor identifier, terminal identifier, PIN, network identifier, issuer data, merchant fraud rate, merchant recovery rate, merchant participation in fraud detection, and/or the like) according to one or more models generated and/or trained based on historical transaction data. The historical transaction data may include previous transactions with the same account identifier, with the same merchant, in the same merchant category, within a geographical location, and/or the like. The fraud risk score 208 output by the fraud risk scoring engine 202 may be any type of metric such as, for example, a value between any range of numbers (e.g., 0 to 1, 0 to 100, 1 to 1000, and/or the like), a percentage, a classification (e.g., low risk, high risk, neutral risk, and/or the like), and/or any other type of measurement. In non-limiting embodiments, the fraud risk engine 202 may generate more than one fraud risk score 208.

Still referring to FIG. 2, the recovery scoring engine 204 is configured to generate a recovery score 210 for a transaction that represents a likelihood that the merchant and/or issuer will recover the transaction value or a portion thereof if the transaction is fraudulent and/or reversed (e.g. credited to the cardholder due to being claimed as fraudulent), disputed, and/or the like. For example, the recovery scoring engine 204 may process transaction parameters from the requested transaction (e.g., merchant identifier, account identifier, MCC, transaction value/amount, date, time, POS entry mode, terminal entry capability, service code, electronic commerce indicator, country code for a merchant, postal code, card acceptor identifier, terminal identifier, PIN, network identifier, issuer data, merchant fraud rate, merchant recovery rate, merchant participation in fraud deflection, and/or the like) according to one or more models generated and/or trained based on historical transaction data. The historical transaction data may include previous transactions with the same account identifier, with the same merchant, in the same merchant category, within a geographical location, and/or the like. The historical transaction data may include fraud rates, dispute rates, recovery rates and outcomes, and/or the like. The recovery score 210 output by the recovery scoring engine 204 may be any type of metric such as, for example, a value between any range of numbers (e.g., 0 to 1, 0 to 100, 1 to 1000, and/or the like), a percentage, a classification (e.g., low likelihood of recovery, high likelihood of recovery, medium likelihood of recovery, and/or the like), or any other type of measurement. The recovery scoring engine 204 may utilize one or more machine learning models to generate the recovery score 210.

With continued reference to FIG. 2, the authorization decision engine 206 is configured to generate an authorization action for a requested transaction, such as denying authorization, granting authorization (e.g., approving authorization), using an alternative or additional authorization mechanism, generating an alert for the transaction, and/or any other action relating to the authorization of the requested transaction. The authorization action may be, for example, a command, notification, message, and/or instruction for how to process the transaction. For example, the authorization action may generate a command configured to cause the transaction processing system and/or issuer system to automatically deny or grant (e.g., approve) authorization. The authorization decision engine 206 may generate the authorization action based on the fraud risk score 208 and the recovery score 210. The authorization action may be any action that is performed upon one or more transactions relating to an authorization process.

In non-limiting embodiments or aspects, the authorization action may be generated based on the fraud risk score 208 and the recovery score 210 satisfying threshold values. The threshold values may be predetermined or dynamically determined. The threshold value for the recovery score 210 may be dependent on the generated fraud risk score 208. In some non-limiting embodiments, the predetermined threshold values may be determined by a machine learning model based on historical transaction data. The threshold value of the fraud risk score 208 may be different than the threshold value of the recovery score 210. The authorization action may be generated based on a combination of the fraud risk score 208 and the recovery score 210 satisfying a threshold value.

In some non-limiting embodiments or aspects, if the fraud risk score 208 satisfies the fraud risk threshold value and the recovery score 210 satisfies the recovery threshold value, the authorization action may be determined to be a denial of the authorization (e.g., a command causing the authorization to be denied). If the fraud risk score 208 satisfies the fraud risk threshold and the recovery score 210 does not satisfy the recovery threshold, the authorization action may be determined to be an authorization grant (e.g., a command causing the authorization to be granted) and generate an alert for the transaction. If the fraud risk score 208 does not satisfy the fraud risk threshold and the recovery score 210 satisfies the recovery threshold, the authorization action may be determined to be an authorization grant (e.g., a command causing the authorization to be granted) and generate an alert for the transaction. If the fraud risk score 208 does not satisfy the fraud risk threshold and the recovery score 210 does not satisfy the recovery threshold, the authorization action may be an authorization grant (e.g., a command causing the authorization to be granted). In non-limiting embodiments, an alert may not be generated and communicated if both thresholds are not satisfied, but may be generated and communicated if one or more thresholds are satisfied.

In some non-limiting embodiments or aspects, the determination of the authorization action is based on the recovery score 210 in response to the fraud risk 208 score satisfying a threshold value. For example, if the fraud risk score 208 satisfies the threshold value, the authorization action may be determined based on the recovery score 210 and the fraud risk score 208. In another example, if the fraud risk score 208 does not satisfy the threshold value, the authorization action may be determined automatically without consideration of the recovery score 210.

As an example, a first transaction may have two fraud risk scores from two separate fraud scoring systems/protocols (e.g., a Visa Advanced Authorization (VAA) score and a Falcon score). For example, a VAA score of 70 and a Falcon score of 750 may result in a denial of authorization. However, the same transaction may have a risk recovery score of 10 (e.g., out of 100) and therefore be associated with a high likelihood of recovery (a low risk of not being able to recover), resulting in an authorization grant. A lower recovery risk score may represent a higher likelihood of recovery. By using different scores, an authorization that would otherwise be denied may be granted, reducing the need for human intervention or additional computing resources necessary to reprocess a denied authorization. In another example, a VAA score of 30 and a Falcon score of 400 may result in a grant of authorization without any additional action. However, the same transaction may have a risk recovery score of 90 and therefore be associated with a low likelihood of recovery (a high risk of not being able to recover), resulting in an authorization grant and generation of an alert. The alert enables intervention and termination of the transaction, a heightened level of scrutiny, and/or the like.

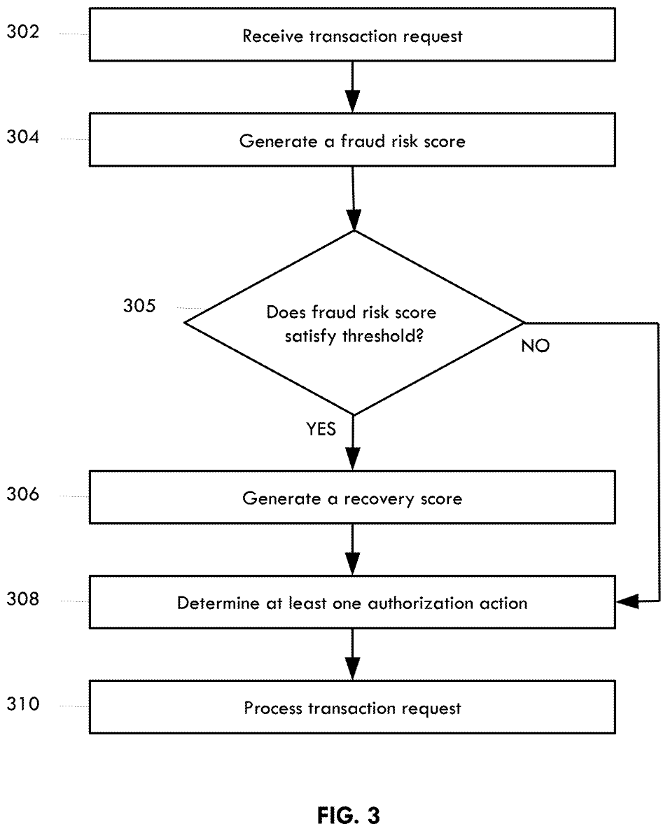

With reference to FIG. 3, a flow diagram is shown according to non-limiting embodiments or aspects. It will be appreciated that, in non-limiting embodiments or aspects, additional, fewer, different, and/or a different order of steps may be used than the example shown in FIG. 3. At step 302, a transaction request is received. The transaction request may include transaction data, including merchant identifier, account identifier, MCC, transaction value, date, time, and/or the like.

With continued reference to FIG. 3, at step 304, a fraud risk score is generated. The fraud risk score represents a likelihood that the requested transaction is fraudulent. The fraud risk score may be generated based on transaction parameters from the requested transaction according to one or more models generated based on historical transaction data. The historical transaction data may include previous transactions with the same account identifier, with the same merchant, in the same merchant category, within a geographical location, and/or the like.

With continued reference to FIG. 3, at step 305, it is determined if a fraud risk score satisfies a threshold. Step 305 may be performed in non-limiting embodiments in which a recovery score determination is bypassed if the fraud risk score is above or below a certain threshold. In other non-limiting embodiments, both scores may be determined regardless of the value of the fraud risk score generated at step 304. For example, if the fraud risk score does satisfy a threshold at step 305, which may be predetermined or dynamically determined, the method may proceed to step 308 in which an authorization action is determined without consideration of a recovery score. If the fraud risk score does not satisfy a threshold, the method may proceed to step 306.

With continued reference to FIG. 3, at step 306, a recovery score is generated. The recovery score represents a likelihood that the merchant and/or issuer will recover the transaction value or a portion thereof if the transaction is fraudulent and/or reversed, disputed, and/or the like. The recovery score may be based on transaction parameters from the requested transaction according to one or more models generated based on historical transaction data. The models may be machine learning models. The historical transaction data may include previous transactions with the same account identifier, with the same merchant, in the same merchant category, within a geographical location, and/or the like. The historical transaction data may include fraud rates, dispute rates, and recovery rates and outcomes. In some non-limiting embodiments or aspects, based on step 305, the recovery score is generated at step 306 in response to the fraud risk score satisfying a threshold.

With continued reference to FIG. 3, at step 308, at least one authorization action is determined. The authorization action may include denying authorization, granting authorization, using an alternative or additional authorization mechanism, generating an alert for the transaction, and/or any other action relating to the authorization of the requested transaction. The authorization action may be, for example, a command, notification, message, and/or instruction for how to process the transaction. For example, the authorization action may be generating a command configured to cause the transaction processing system and/or issuer system to automatically deny or grant authorization.

In some non-limiting embodiments or aspects, the authorization action may be determined based on the fraud risk score and/or the recovery score. For example, the determination may depend on the satisfaction of predetermined threshold values for the fraud risk score and/or the recovery score. The threshold value for the fraud risk score may be the same as or different than the threshold value for the recovery score. The threshold value for the recovery score may be dependent on the generated fraud risk score. The authorization action may be determined based on a predetermined threshold value of the combined fraud risk score and recovery score. The predetermined threshold values may be determined by a machine learning model based on historical transaction data.

In some non-limiting embodiments or aspects, if the fraud risk score satisfies the fraud risk threshold value and the recovery score satisfies the recovery threshold value, the authorization action may be determined to comprise granting the authorization. If the fraud risk score satisfies the fraud risk threshold and the recovery score does not satisfy the recovery threshold, the authorization action may be determined to comprise granting the authorization and generating an alert for the transaction. If the fraud risk score does not satisfy the fraud risk threshold and the recovery score satisfies the recovery threshold, the authorization action may be determined to comprise granting the authorization and generating an alert for the transaction. If the fraud risk score does not satisfy the fraud risk threshold and the recovery score does not satisfy the recovery threshold, the authorization action may be determined to comprise denying the authorization.

With continued reference to FIG. 3, at step 310, the transaction request is processed based on the authorization action. Processing the transaction request may include causing a transaction processing system and/or issuer system to automatically deny or grant authorization of the transaction request. Processing the transaction request may include generating and communicating an alert. The alert may be sent by communicating the alert to an issuer institution and/or transaction service provider. The alert may indicate the fraud risk score and/or the recovery score of the transaction and permit a system or individual to intervene.

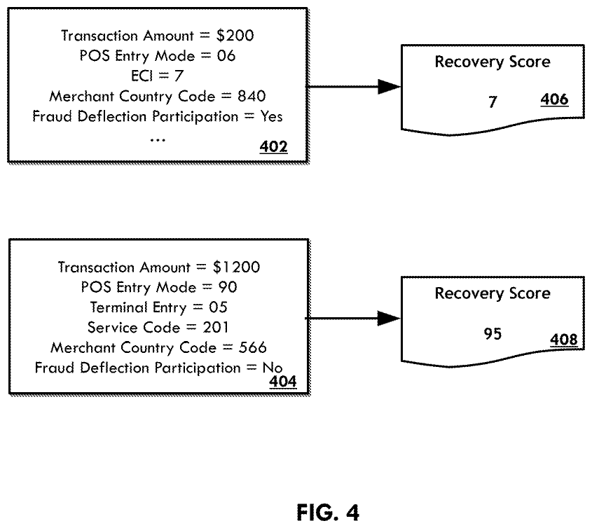

Referring now to FIG. 4, shown are two recovery score determinations according to non-limiting embodiments. In each example, a set of input parameters 402, 404 result in a respective recovery score 406, 408. In this example, the scores are 7 and 95. Input parameters 402 result in a low recovery score (7) (e.g., a low risk of not being able to recover) due in part to the merchant country code (840 corresponding to the United States), relatively low transaction value ($200), and participation in fraud deflection services. Each of these parameters and others may be weighted to calculate the recovery score. Input parameters 404 result in a high recovery score (95) (e.g., a high risk) due in part to the merchant country code (566 corresponding to Nigeria), relatively high transaction value ($1200), and lack of participation in fraud deflection services. Each of these parameters and others may be weighted to calculate the recovery score.

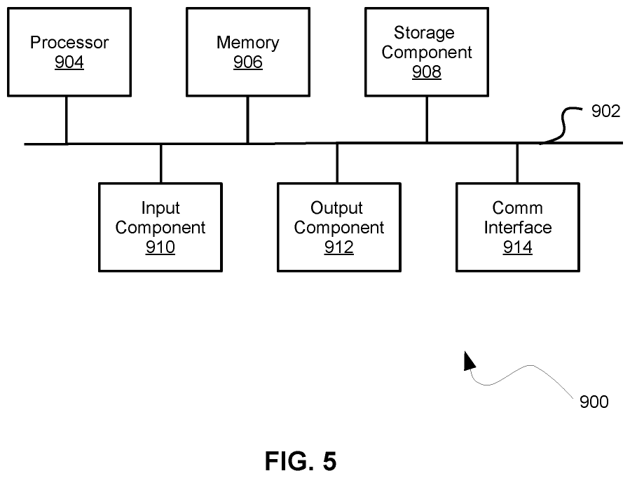

Referring now to FIG. 5, shown is a diagram of example components of a device 900 according to non-limiting embodiments. Device 900 may correspond to the transaction processing system 102, issuer system 106, risk engine 110, and/or merchant system 109 in FIG. 1, as an example. In some non-limiting embodiments, such systems or devices may include at least one device 900 and/or at least one component of device 900. The number and arrangement of components shown are provided as an example. In some non-limiting embodiments, device 900 may include additional components, fewer components, different components, or differently arranged components than those shown in FIG. 1. Additionally, or alternatively, a set of components (e.g., one or more components) of device 900 may perform one or more functions described as being performed by another set of components of device 900.

As shown in FIG. 5, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 5, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A computer-implemented method, comprising:
receiving, with at least one processor, a transaction request for a payment transaction to be made from an account of a user to a merchant, the transaction request comprising transaction data including a payment amount;
generating, with at least one processor, a fraud risk score based on the transaction data and merchant data associated with the merchant, the fraud risk score representing a likelihood that the payment transaction is fraudulent;
generating, with at least one processor, a recovery score based on the transaction data and merchant data associated with the merchant, the recovery score representing a likelihood that an issuer system associated with the account of the user will be able to recover at least a portion of the payment amount if the payment transaction is reversed;
determining, with at least one processor, at least one authorization action for processing the transaction request based on the recovery score and the fraud risk score; and
processing, with at least one processor, the transaction request based on the at least one authorization action.

2. The computer-implemented method of claim 1, wherein processing the transaction request occurs at a point of sale.

3. The computer-implemented method of claim 1, wherein the at least one authorization action is determined based on the recovery score in response to determining that the fraud risk score is above a threshold value.

4. The computer-implemented method of claim 1, wherein the recovery score is generated based on at least one machine learning model.

5. The computer-implemented method of claim 1, wherein the at least one authorization action comprises approving the transaction request and sending an alert, and wherein determining the at least one authorization action comprises determining the fraud risk is below a threshold value and the recovery score is above a threshold value.

6. The computer-implemented method of claim 1, wherein the at least one authorization action comprises approving the transaction request and sending an alert, and wherein determining the at least one authorization action comprises determining the fraud risk is above a threshold value and the recovery score is below a threshold value.

7. The computer-implemented method of claim 1, wherein the at least one authorization action comprises approving the transaction request, and wherein determining the at least one authorization action comprises determining the fraud risk is below a threshold value and the recovery score is below a threshold value.

8. The computer-implemented method of claim 1, wherein the at least one authorization action comprises declining the transaction request, and wherein determining the at least one authorization action comprises determining the fraud risk is above a threshold value and the recovery score is above a threshold value.

9. A system for processing a transaction, the system comprising at least one server computer including at least one processor, the at least one server computer programed and/or configured to:
receive a transaction request for a payment transaction to be made from an account of a user to a merchant, the transaction request comprising transaction data including a payment amount;
generate a fraud risk score based on the transaction data and merchant data associated with the merchant, the fraud risk score representing a likelihood that the payment transaction is fraudulent;
generate a recovery score based on the transaction data and merchant data associated with the merchant, the recovery score representing a likelihood that an issuer system associated with the account of the user will be able to recover at least a portion of the payment amount if the payment transaction is reversed;
determine at least one authorization action for processing the transaction request based on the recovery score and the fraud risk score; and
process the transaction request based on the at least one authorization action.

10. The system of claim 9, wherein the at least one server computer is programed and/or configured to, process the transaction request at a point of sale.

11. The system of claim 9, wherein the at least one server computer is programed and/or configured to, when determining the at least one authorization action, base the determination of the at least one authorization action on the recovery score in response to determining that the fraud risk score is above a threshold value.

12. The system of claim 9, wherein the at least one server computer is programed and/or configured to generate the recovery score based on at least one machine learning model.

13. The system of claim 9, wherein the at least one server computer is programed and/or configured to, when determining the at least one authorization action, determine the fraud risk is below a threshold value and the recovery score is above a threshold value, and when processing the transaction request based on the at least one authorization action, approve the transaction request and send an alert.

14. The system of claim 9, wherein the at least one server computer is programed and/or configured to, when determining the at least one authorization action, determine the fraud risk is above a threshold value and the recovery score is below a threshold value, and when processing the transaction request based on the at least one authorization action, approve the transaction request and send an alert.

15. The system of claim 9, wherein the at least one server computer is programed and/or configured to, when determining the at least one authorization action, determine the fraud risk is below a threshold value and the recovery score is below a threshold value, and when processing the transaction request based on the at least one authorization action, approve the transaction request.

16. The system of claim 9, wherein the at least one server computer is programed and/or configured to, when determining the at least one authorization action, determine the fraud risk is above a threshold value and the recovery score is above a threshold value, and when processing the transaction request based on the at least one authorization action, decline the transaction request.

17. A computer program product for processing a transaction, comprising at least one non-transitory computer-readable medium including program instructions that, when executed by at least one processor, cause the at least one processor to:
receive a transaction request for a payment transaction to be made from an account of a user to a merchant, the transaction request comprising transaction data including a payment amount;
generate a fraud risk score based on the transaction data and merchant data associated with the merchant, the fraud risk score representing a likelihood that the payment transaction is fraudulent;
generate a recovery score based on the transaction data and merchant data associated with the merchant, the recovery score representing a likelihood that an issuer system associated with the account of the user will be able to recover at least a portion of the payment amount if the payment transaction is reversed;
determine at least one authorization action for processing the transaction request based on the recovery score and the fraud risk score; and
process the transaction request based on the at least one authorization action.

18. The computer program product of claim 17, wherein the one or more instructions further cause the at least one processor to process the transaction request at a point of sale.

19. The computer program product of claim 17, wherein the one or more instructions further cause the at least one processor to, when determining the at least one authorization action, determine the fraud risk is below a threshold value and the recovery score is below a threshold value, and when processing the transaction request based on the at least one authorization action, approve the transaction request.

20. The computer program product of claim 17, wherein the one or more instructions further cause the at least one processor to, when determining the at least one authorization action, determine the fraud risk is above a threshold value and the recovery score is above a threshold value, and when processing the transaction request based on the at least one authorization action, decline the transaction request.
